(19) United States
(12) Patent Application Publication
(10) Pub. No.: US 2007/0267280 A1
(43) Pub. Date: Nov. 22, 2007

(54) Connecting Element for Connecting Two Servince Devices Arranged with Their Broad Sides Next to One Another

(75) Inventors: Alexander Orban, Weinheim (DE); Rudolf Sellner, Hockenheim (DE)

Correspondence Address: BUCHANAN, INGERSOLL & ROONEY PC, POST OFFICE BOX 1404, ALEXANDRIA, VA, 22313-1404, US

(73) Assignee: ABB PATENT GMBH, Ladenburg (DE)

(21) Appl. No.: 11/661,596

(22) PCT Filed: Aug. 11, 2005
(86) PCT No.: PCT/EP05/08703

§ 371 Date: Mar. 1, 2007

(30) Foreign Application Priority Data
Sep. 2, 2004 (DE) 10 2004 042 426.8

(51) Int. Cl. H01H 9/00

(52) U.S. Cl. 200/17 R

(57) ABSTRACT

The invention relates to a connecting element for connecting two installation units that are positioned side by side with adjacent broad sides, in particular, circuit-breakers residual-current circuit-breakers or similar, at least one of said units having a narrower module width in relation to the normal module width of an installation unit. Said element can be used for example to connect an auxiliary switch to a circuit-breaker or residual-current circuit-breaker, or an auxiliary switch to a starting-circuit breaker, or an additional auxiliary switch to starting-circuit breaker, or an additional auxiliary switch to an auxiliary switch. The connecting element comprises a base body section with two sprung arms that project in parallel. Lugs that project radially outwards and follow diametrically opposed sawtooth lines are formed on the free ends of said arms and the end of the connecting element that lies opposite said arms comprises a peripheral strip that acts as the head. The inner faces of the arms are provided with elements in the vicinity of the lugs, said elements limiting the compression of the arms during the connection operation.

The invention relates to a connecting element in accordance with the precharacterizing clause of claim 1.

Electrical line circuit breakers have a single-pole or multi-pole design. In order to achieve a multi-pole arrangement, a number of line circuit breaker poles which corresponds to the number of poles or phases is arranged with their broad sides next to one another in a row and connected to one another. This connection usually takes place by means of riveted joints. Spreading connectors are also known which have a cylindrical section, spreading arms which protrude on both sides in opposite directions and, in the fitted state, engage with radial tabs behind recesses in each pole being integrally formed on the front side of said cylindrical section.

These spreading connectors are only suitable for those line circuit breakers which have at least a standard module width of 17.5 mm.

The connecting elements in accordance with parallel applications are suitable for those line circuit breakers which have at least a standard module width of 17.5 mm.

It is of course also possible for residual-current circuit breakers to be connected to one another in this manner, or line circuit breakers having residual-current circuit breakers.

Auxiliary switches which have only half a module width are often placed on line or residual-current circuit breakers. In order to fix such auxiliary switches having a small module width, riveted joints are usually used as the connecting elements since the length of the rivet can be determined simply. The production of a riveted joint is complex since special tools are required. Owing to the forces which need to be applied for riveting purposes, it may arise that the housings of the service devices are damaged.

One object of the invention is to provide a connecting element in accordance with the precharacterizing clause of claim 1 with the aid of which even switches having a smaller module width than the standard module width can be placed on another service device in a simple manner.

This object is achieved according to the invention by the features of claim 1.

According to the invention, the connecting element has a basic body section, at whose one end two sprung arms protrude parallel to one another, tabs, which protrude radially outwards on diametrically opposing surface lines being formed integrally on the free ends of said sprung arms. A peripheral strip which acts as the head is located at that end of said surface line which is opposite the arms. Means are arranged on the inner sides of the arms in the region of the tabs and are used for limiting the degree to which the arms are pushed together during the latching process. After latching, the head engages behind a recess on one switching device, and the tab of the arms engages behind a recess on the other switching device.

As a result of the fact that the two sprung arms are arranged on the basic body section only on one side, whereas the head rests at the other end, the total length of the connecting element is reduced, with the result that a service device having a smaller width than the standard module width of 17.5 mm can be connected in a simple manner to another service device and fixed thereto.

In a preferred manner, the connecting element is fitted such that the head is located in the service device having a smaller module width.

The means which serve the purpose of limiting the degree to which the arms are pushed together during the latching process can be formed by a transverse plate which connects the ends of the arms to one another, can be deformed in a sprung manner and also has the advantage that it acts in a sprung manner on the arms in the spreading direction.

Furthermore, a spring element may be provided which, in accordance with one particularly advantageous refinement of the invention, has a Z shape, whose one limb is connected to an edge of one arm and whose gate limb is connected to the opposite edge of the arm. This is intended to mean the longitudinal edges of the arms.

It is also possible for at least one protrusion to be integrally formed on at least one of the opposing inner faces of the arms in the region of the tabs, which protrusion protrudes towards the inner face of the other arm and serves the purpose of limiting the movement of the arms towards one another.

If in each case one protrusion is integrally formed on the inner face of each arm, which protrusion protrudes towards the opposing inner face, the protrusions are offset with respect to one another in a particularly advantageous manner, with the result that they slide past one another when pushed together.

The flanks sliding past one another can also form an angled face and run parallel to one another, with the result that the two protrusions slide onto one another.

The tabs used for latching may have a saw-tooth shape, whose steeper face is directed towards the head. Both saw-tooth faces may be conical.

The invention and further advantageous refinements and improvements of the invention and further advantages will be explained and described in more detail with reference to the drawing, in which a few exemplary embodiments of the invention are illustrated and in which:

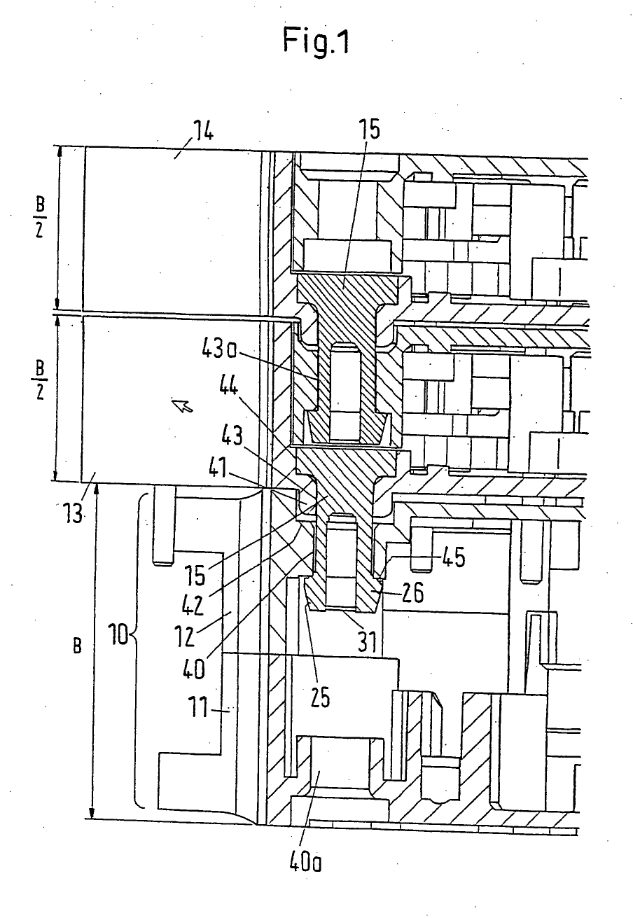

FIG. 1 shows a sectional view through an arrangement of a line circuit breaker and two auxiliary switches,

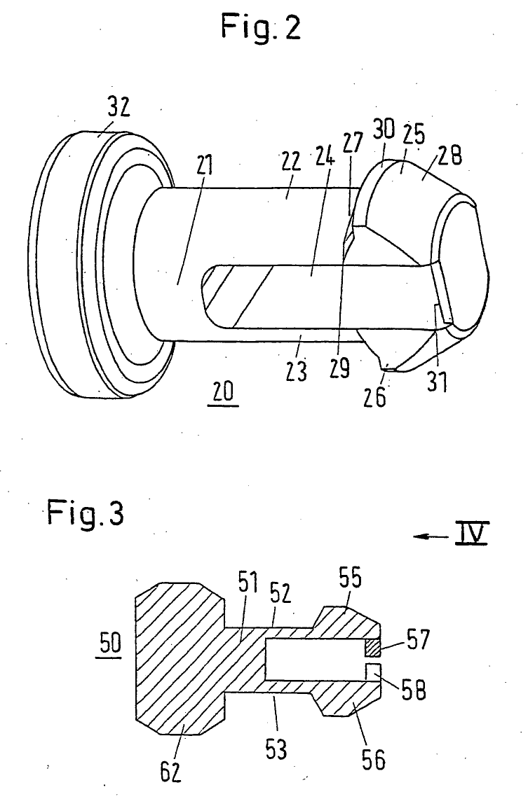

FIG. 2 shows a perspective view of a first embodiment of a connecting element,

FIG. 3 shows a sectional view through a second embodiment of the connecting element,

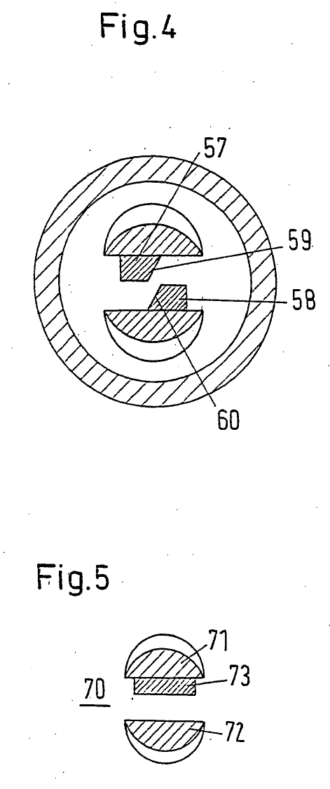

FIG. 4 shows a view in accordance with the arrow direction IV in FIG. 3,

FIG. 5 shows a partial view of a third embodiment of a connecting element, in the illustration shown in FIG. 4, and

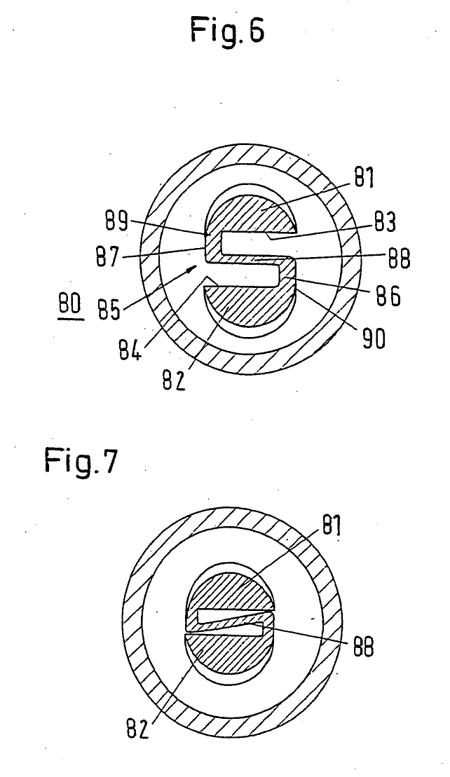

FIGS. 6 and 7 show a fourth embodiment of a connecting element according to the invention in the illustration shown in FIG. 4, in two different installed positions.

Reference will now be made to FIG. 1.

Two auxiliary switches 13 and 14 are arranged with their broad sides next to one another in a row on a line circuit breaker 10, whose housing comprises two housing half-shells 11, 12, which are positioned facing one another with their free edges; the two auxiliary switches 13 and 14 have half the module width B/2 of the module width B of the line circuit breaker 10.

The auxiliary switch 13 is connected to the line circuit breaker 10 by means of a connecting element 15, and the auxiliary switch 14 is connected to the auxiliary switch 13 with a connecting element having an identical design and therefore having the same reference numeral 15, and they are fixed thereto.

The internal components both of the line circuit breaker 10 and the two auxiliary switches 13 and 14 have no importance with respect to the invention.

Reference will now be made to FIG. 2, in which a connecting element of a first embodiment is illustrated. The connecting element has the reference numeral 20 and has a basic body 21, two arms 22 and 23, which run parallel to one another, protrude in the axial direction from the basic body and are separated from one another by means of a slot 24, being integrally formed on one front face of said basic body. The basic body 21, also referred to as the basic body section 21, is cylindrical, and the outer faces of the arms 22 and 23 are therefore likewise in the form of a cylinder segment.

Latching tabs 25 and 26, which are positioned diametrically opposite one another, protrude towards the outside and form a type of saw-tooth shape in longitudinal section, are integrally formed at the free ends of the arms 22 and 23, the saw-tooth wall 27, which faces the basic body section 21, assuming a steeper angle with respect to the longitudinal axis of the connecting element 20 than the opposite angled face 28. The angled faces 27 and 28 in each case correspond to the form of a cone; a radially running circular arc face 29 and, adjacent thereto, a cylinder arc face 30 are located between the angled faces 27 and 28, with the result that the transition between the angled face 27 and the angled face 28 is stepped.

The two arms 22, 23 are connected at the free end by means of a cover plate 31, which is dimensioned to be so thin that it bends out in a sprung manner when the arms 22, 23 are pushed towards one another.

A peripheral strip 32, which represents a head, is integrally formed at that end of the basic body 21 which is opposite the arms 22, 23; the outer diameter of the strip 32 or the head 32 is larger than the outer diameter of the cylinder arc face 30 of the tab 25, 26.

The connecting element 20 in FIG. 2 corresponds in an identical manner to the connecting element 15.

In order that the connecting element 20 (or else 15) can be fitted, the shell 12 of the line circuit breaker has a cylindrical aperture 40, whose inner diameter corresponds to the outer diameter of the arms 22 and 23 and the basic body 21. On the broad side facing the line circuit breaker 10, the auxiliary switch 13 or the housing of the auxiliary switch 13 has a collar-like protrusion 41 towards the outside, which runs at right angles to the broad side and can engage in a recess 42, which is matched thereto, on the housing of the line circuit breaker 10; the protrusion or the collar 41 surrounds a through-opening 43, whose inner diameter corresponds to the inner diameter of the opening 40; on the inner side of the housing of the auxiliary switch 13, this aperture 43 merges in a stepped manner with a circular depression 44, into which the head 32 fits; the depth of this depression corresponds to the axial extent of the head 32.

For fitting purposes, the auxiliary switch 13 is accordingly placed onto the broad side of the line circuit breaker 10 and then the connecting element 15 or 20 is inserted into the depression of the housing of the auxiliary switch 13 until the tabs 25, 26 engage behind a recess 45, which surrounds the aperture 40 and is aligned radially with respect to the aperture 40. The head 32 therefore rests in the depression 44. The cone face 27 bears against the inner edge of the recess 45, as a result of which, owing to the cone face 27, the auxiliary switch 13 is fixed to the line circuit breaker 10 and tolerances are compensated for. During the insertion operation, the tabs 25, 26 slide through the aperture 40, the arms 22, 23 being pushed towards one another and, in the process, the transverse plate 31 being deformed. Once the arms 22, 23 have been latched in behind the recess 45 or are located behind this recess, the transverse plate 31 pushes the two arms apart from one another again in a sprung manner.

In a similar manner, the auxiliary switch 14 is also fixed to the auxiliary switch 13.

In the embodiment shown in FIG. 1, the housing of the line circuit breaker 10 has the two half-shells 11 and 12, which have a similar design in the region of the latching, the half-shell 11 having an aperture 40a in its broad-side wall, which aperture 40a corresponds to the aperture 40 and therefore has retained the same reference numeral with the index a. In the same manner, the auxiliary switch housing is also provided with, in addition to the aperture 43, an aperture 43a, which also corresponds to the aperture 40.

FIG. 3 shows a second embodiment of the invention. A connecting element 50 has a basic body 51, which corresponds to the basic body 21 and on which two arms 52 and 53, which run parallel to one another, are integrally formed; tabs 55, 56, which correspond to the tabs 25, 26, are located at the ends of the arms 52, 53; furthermore, the connecting element 50 also has a head 62, which corresponds to the head 32.

Stops 57 and 58 are integrally formed on the inner faces of the ends of the arms 52 and 53, which stops are integrally formed at right angles thereto and are laterally offset with respect to one another in relation to the longitudinal axis, as can be seen from FIG. 4. The two protrusions 57 and 58 have side flanks 59 and 60, which are aligned at an angle with respect to the arms 52, 53, these side flanks running parallel to one another. When the connecting element 50 is inserted into the aperture 43, 40, the arms 52, 53 are pushed towards one another, and the side flanks 59, 60 slide-onto one another; this refinement shown in FIG. 4 in any case means that the two arms 52, 53 can only be pushed together until the protrusions 57, 58 either slide onto one another or come to bear against the respective inner faces of the opposing arms.

In the embodiment shown in FIG. 5, the connecting element 70 has two arms 71, 72, which correspond in principle to the arms 22, 23. Instead of the protrusions 57 and 58, only one protrusion 73 is located on one arm 71, which protrusion 73 bears against the inner face of the other arm 72 when the two arms are pushed together.

In the embodiment shown in FIGS. 6 and 7, which represent a connecting element 80 in the view shown in FIG. 4, two arms 82 are provided which correspond to the arms 22, 23 and likewise have inner faces 83, 84, which run parallel to one another and are directed towards one another. Instead of the protrusions 57 and 58 or the protrusion 73, a spring element 85, which has a Z shape, is located between the two inner faces 83, 84; one free limb 86 of the Z shape adjoins the inner face 84, and the other free limb 87 adjoins the inner face 83, in each case at right angles; the web 88 between the two limbs runs parallel to the inner faces 83, 84. It can be seen from FIG. 6 that the limb 87 adjoins an edge 89 of the arm 81, and the limb 86 adjoins the opposite edge 90 of the arm 82.

FIG. 7 shows the embodiment shown in FIG. 6 at the instant at which the tabs slide through the holes or apertures 43, 40; in this case, the inner faces 83, 84 approach one another until the limbs 86, 87 rest on the respectively opposing inner faces 83, 84 and the web 88 runs at an angle to the inner faces 83, 84 and, in the process, the connecting element 85 is deformed in a sprung manner. The connecting element 85 can therefore push the two arms 81, 82 apart from one another again if the end position has been reached.

The transverse plate 31 and the protrusions 57, 58 or the protrusion 73 and the spring 85 are integrally formed at the free ends of the arms, to be precise in each case on one or both inner faces, which point towards one another, of the arms 22, 23; 52, 53; 71, 72; 81, 82.

1. A connecting element for connecting two service devices arranged with their broad sides next to one another, in particular line circuit breakers, residual-current circuit breakers or the like, of which at least one has a module width which is smaller than the normal module width of a service device, for example for the purpose of connecting an auxiliary switch to a line circuit breaker or residual-current circuit breaker or an auxiliary switch to a motor circuit breaker or a further auxiliary switch to the auxiliary switch, wherein the connecting element has a basic body section at whose one end two sprung arms protrude axially from the basic body parallel to one another, tabs which protrude radially outwards on diametrically opposing surface lines being formed integrally at the free ends of said sprung arms, and at whose end which is opposite the arms a peripheral strip is arranged which acts as the head, and in that means are arranged on the inner sides of the arms in the region of the tabs and are used for limiting the degree to which the arms are pushed together during the latching process such that the head engages behind a recess on one switching device, and the tab of the arms engages behind a recess on the other switching device.

2. The connecting element as claimed in claim 1, wherein the head is located in the service device having a smaller module width.

3. The connecting element as claimed in claim 1, wherein the means are formed by a transverse plate which connects the ends of the arms to one another, can be deformed in a sprung manner and also acts in a sprung manner on the arms in the spreading direction.

4. The connecting element as claimed in claim 1, wherein a spring element is provided between the free ends of the arms.

5. The connecting element as claimed in claim 4, wherein the spring element has a Z shape, whose one limb is connected to a longitudinal edge of one arm and whose other limb is connected to the opposite longitudinal edge of the other arm.

6. The connecting element as claimed in claim 1, wherein at least one protrusion is provided on at least one of the opposing inner faces of the arms in the region of the tabs protrudes towards the inner face of the other arm and serves the purpose of limiting the movement of the arms towards one another.

7. The connecting element as claimed in claim 6, wherein in each case one protrusion is integrally formed on the inner face of each arm which protrusion protrudes towards the opposing inner face, and in that the protrusions are offset with respect to one another.

8. The connecting element as claimed in claim 7, wherein the flanks which slide past one another, of the protrusions are in the form of angled faces and run parallel to one another.

9. The connecting element as claimed in claim 1, wherein the tabs have a saw-tooth shape, the steeper face being directed towards the head.

10. The connecting element as claimed in claim 9, wherein the saw-tooth faces are each faces of a cone.
